(19) United States
(12) Patent Application Publication
(10) Pub. No.: US 2006/0098952 A1
(43) Pub. Date: May 11, 2006

(54) Method and system for recording and reproducing data

(75) Inventors: Masahiro Fujimoto, Hitachinaka (JP); Hiroaki Tachibana, Hitachinaka (JP); Toshiyuki Yokoyama, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/123,818

(22) Filed: May 6, 2005

(30) Foreign Application Priority Data
Nov. 8, 2004 (JP) 2004-323084

(51) Int. Cl. H04N 7/26; H04N 5/225

(52) U.S. Cl. 386/111; 386/117

(57) ABSTRACT

Conventional transcoding techniques cannot generate a continuous encoded stream when the transcode operation is interrupted due to insufficient power, etc. and later resumed, causing a degradation in the quality of the image or sound at the point of interruption. A transcoding technique of the present invention determines whether a transcode operation is to be interrupted due to power failure, etc. and if so, stores coding information required to resume the transcode operation at the point of interruption.

### PRIORITY OF CLAIM

This application claims the benefit of priority of Japanese Application No. 2004-323084 filed Nov. 8, 2004, the disclosure of which also is entirely incorporated herein by reference.

### BACKGROUND OF THE INVENTION

The present invention relates to a data processing method and apparatus for interrupting and resuming a transcode operation.

In the Internet and client/server environments, the size of data handled must be small. However, MPEG-2 (an MPEG standard format defined by the Moving Picture Experts Group) requires a large number of bits to represent each picture or sound. Therefore, in recent years, data attached to a Web page or mail has been converted into MPEG-4 format which requires a smaller number of bits before uploading the Web page or transmitting the mail. The conversion from MPEG-2, etc. to MPEG-4 is achieved by use of a transcode function (that is, a dubbing function for converting a code format or changing a coding rate) which reads out and decodes MPEG-2 encoded data written on a recording medium, re-encodes the decoded data into MPEG-4 format, and stores it on the recording medium.

Incidentally, a transcode operation may be interrupted due to various reasons. If a transcode operation is interrupted and later resumed, the transcoded stream data becomes discontinuous at the point of interruption. Therefore, when the transcode operation has been interrupted, it is necessary to transcode the original data again from its beginning, meaning that the previously obtained transcoded stream data has been wasted.

A technique for preventing transcoded stream data from becoming discontinuous due to interruption of the transcode operation is to store in an interruption point storing unit information on the points of interruption on the read and write media and, when the transcode operation is resumed, retrieve this information from the interruption point storing unit and start the operation at these points of interruption so that the transcoded stream data is continuous (see, e.g., Japanese Patent Laid-Open No. 2001-94935).

### SUMMARY OF THE INVENTION

Since an MPEG system encodes the current image using a portion of the previously encoded data, the coding rate or the amount of data encoded per second varies according to the rate of change of the input image or sound. The coding rate is not fixed at its initial value. This arrangement allows the coding rate to be increased when a complicated image or a fast-moving image is encoded, making it possible to efficiently generate stream data while maintaining the quality of the image or sound. For example, after being initially set to 5 Mbps (megabit per second), the coding rate may increase to as high as 10 Mbps when a complicated image or a fast-changing image is encoded, which requires a large amount of data to be processed. Assume, therefore, that a transcode operation is interrupted when the coding rate has been increased to 10 Mbps to process a large amount of data. In such a case, resuming the transcode operation with the coding rate set to the initial value 5 Mbps leads to a reduction in the amount of information which can be retrieved and hence a degradation in the quality of the image and sound.

The technique disclosed in the above patent publication stores information on the points of interruption of a transcode operation in units of GOP (Group of Pictures), which allows continuous stream data to be generated when the transcode operation is resumed. However, the above technique does not consider to store information as to the coding rate. Therefore, if a transcode operation to convert one MPEG format to another MPEG format has been interrupted, it must be resumed with the coding rate set to its initial value, since no information on the value of the coding rate other than the initial value is available. This makes the transcoded stream data discontinuous in terms of coding rate, resulting in a degradation in the quality of the image and sound around the point of interruption.

An object of the present invention is to solve the problems described above.

When transcoding encoded data, the present invention determines whether the transcode operation is to be interrupted, and if so, interrupts the operation after storing the current coding rate.

The above arrangement allows the performance of the recording/reproducing apparatus to be increased.

### BRIEF DESCRIPTION OF THE DRAWINGS

These and other features, objects, and advantages of the present invention will become more apparent from the following description when taken in conjunction with the accompanying drawings wherein:

FIG. 1 is a circuit block diagram showing a camera-equipped recording/reproducing apparatus according to an embodiment of the present invention;

FIG. 2 is a block diagram showing the internal workings of an encode/decode processing circuit 7 and some components connected thereto for achieving a transcode function according to the embodiment;

FIG. 3 is a flowchart showing the basic transcode operation performed by the camera-equipped recording/reproducing apparatus of the present embodiment upon reception of a request for transcoding; and

FIG. 4 is a flowchart showing the basic transcode operation performed by the camera-equipped recording/reproducing apparatus of the present embodiment upon reception of a request for resumption of a transcode operation.

### DETAILED DESCRIPTION OF PREFERRED EMBODIMENTS

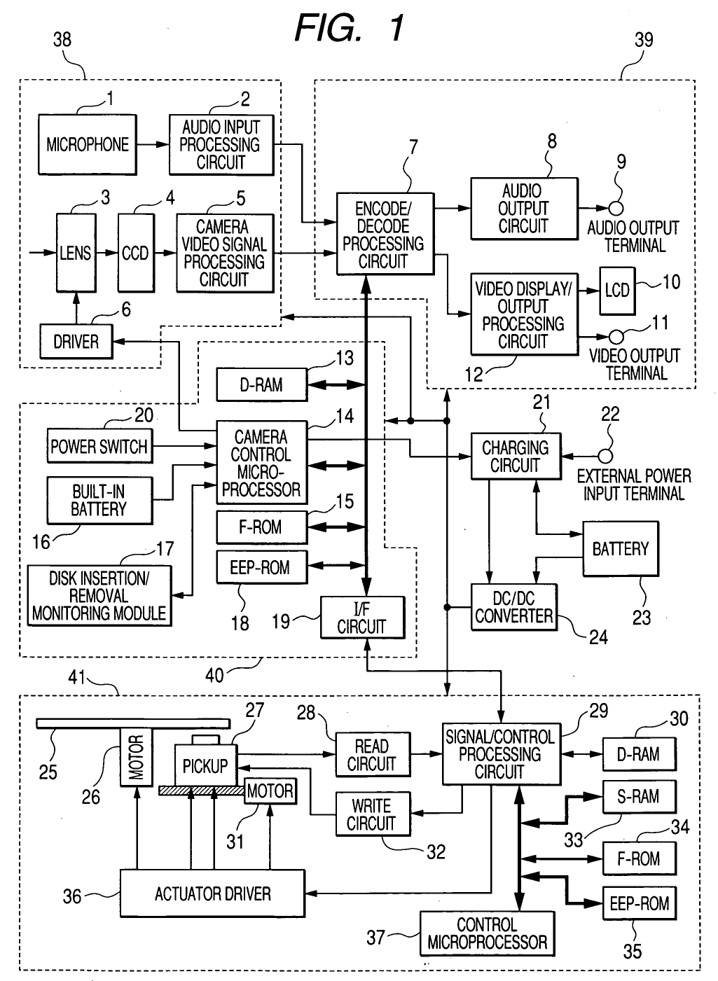

A preferred embodiment of the present invention will be described below with reference to FIGS. 1 to 4. It should be noted that in the following example, an optical disk is used as a recording medium and a transcode operation is performed to transcode an MPEG-2 encoded signal read from the optical disk into MPEG-4 format and write it back to the optical disk.

FIG. 1 is a block diagram showing a camera-equipped recording/reproducing apparatus employing an optical disk recording medium according to the present embodiment. In the figure, reference numeral 1 denotes a microphone; 2, an audio input processing circuit; 3, a lens unit; 4, an imaging sensor (CCD: Charge-Coupled Device); 5, a camera video signal processing circuit; 6, a driver for the lens unit 3; 7, an encode/decode processing circuit; 8, an audio output circuit; 9, an audio output terminal; 10, a display means (LCD: Liquid Crystal Display); 11, a video output terminal; 12, a video display/output processing circuit; 13, D-RAM (Dynamic Random Access Memory); 14, a camera control microprocessor on the camera side; 15, F-ROM (Flash Read Only Memory); 16, a built-in battery; 17, a disk insertion/removal monitoring module; 18, EEP-ROM (Electronically Erasable and Programmable Read Only Memory); 19, an interface (I/F) circuit; 20, the power switch (SW) of this apparatus; 21, a charging circuit; 22, an external power input terminal; 23, a battery; 24, a power supply circuit (DC/DC converter); 25, a disk medium; 26, a spindle motor; 27, a pickup for writing/reading to/from the disk medium 25; 28, a read circuit; 29, a signal/control processing circuit for the disk medium 25; 30, D-RAM; 31, a slide (or feed) motor for moving the pickup 27 over the disk medium 25; 32, a write circuit; 33, S-RAM (Static Random Access Memory); 34, F-ROM (flash memory); 35, EEP-ROM (nonvolatile memory); 36, actuator drivers for driving the spindle motor 26, the slide or feed motor 31, and the focus direction actuator and the tracking direction actuator (not shown) within the pickup 27; 37, the control microprocessor in a read/write unit 41; 38, a camera unit; 39, an output unit; 40, a control unit; and 41, the read/write unit. The above memories are used for applications that fit their characteristics. The D-RAM 13 temporarily stores a large amount of data such as the data processed by the encode/decode processing circuit 7 and the camera control microprocessor 14. The S-RAM 33 is used to temporarily store the working data handled by the control microprocessor 37. The flash memory 15 stores programs, etc. for operating the camera control microprocessor 14. The EEP-ROMs 18 and 35 are used to store information on the states of the mechanisms, etc. in the camera unit 38 and in the read/write unit 41, respectively. Flash memory and EEP-ROM are both electrically writable and erasable nonvolatile memory. EEP-ROM has a small capacity and is used for low cost applications, while flash memory is used to store a large amount of information.

The operation of the camera unit 38 will now be described. The imaging sensor (CCD) 4 captures image information through the lens unit 3 driven by the driver 6 and converts it into an electronic signal. The electronic signal is then converted into a video signal by the camera video signal processing circuit 5 and input to the encode/decode processing circuit 7. On the other hand, the microphone 1 captures sound and converts it into an electronic signal. The electronic signal is then converted into an audio signal by the audio input processing circuit 2 and input to the encode/decode processing circuit 7.

The operation of the output unit 39 will now be described. The encode/decode processing circuit 7 digitizes and encodes the input video and audio signals into respective digital signals. Specifically, the encode/decode processing circuit 7 encodes the input signals by use of an MPEG system or a JPEG (Joint Photographic Experts Group) system. The MPEG system is used to encode moving images, while the JPEG system is used to encode still images. The digital audio signal output from the encode/decode processing circuit 7 is input to the audio output terminal 9 through the audio output circuit 8. The digital video signal from the encode/decode processing circuit 7, on the other hand, is input to the display means (LCD) 10 for display and to the video output terminal 11 through the video display/output processing circuit 12.

The operation of the control unit 40 will now be described. This unit detects the operation of the power switch 20 and starts to operate when the power switch 20 has been turned on and required voltages and currents have been supplied from the power supply unit to each circuit and each means of this unit. The camera control microprocessor 14 controls the lens unit 3 through the driver 6 such that the imaging sensor (CCD) 4 captures a desired image of the object. The camera control microprocessor 14 also controls the encode/decode processing circuit 7 such that the encode/decode processing circuit 7 digitizes and encodes a moving image or a still image into a digital signal and temporarily stores it in the D-RAM 13. This digital signal is sent to the signal/control processing circuit 29 in the read/write unit 41 through the interface circuit 19. The camera control microprocessor 14 also monitors the charging circuit 21 to check the state of the power supply as well as detecting the operation of the power switch 20 to perform processing for power supply to the camera unit 38. The built-in battery 16 is used to store backup information, such as date, supplied to the camera control microprocessor 14. The disk insertion/removal monitoring means (module) 17 monitors whether the disk medium 25 has been inserted or removed. This means may be implemented by a switch provided on the insertion slot to detect the presence or absence of the disk medium 25. It should be noted that the above detection switch is energized by the battery 23 and has an electronic signal output.

The operation of the read/write unit 41 will now be described. The read/write unit 41 converts the digital signal (a moving image or a still image) received through the interface circuit 19 into a recording format suitable for the disk medium 25 by use of the signal/control processing circuit 29 and the D-RAM 30 and stores it on the disk medium 25 through the write circuit 32 and the pickup 27. Further, to control the relative position between the disk medium 25 and the pickup 27, the read/write unit 41 reads from the pickup 27 in a time division manner and thereby detects positional information prewritten on the disk medium 25 through the read circuit 28, processes the detected positional information by use of the signal/control processing circuit 29 and the control microprocessor 37, and drives the spindle motor 26, the slide (or feed) motor 31, and the focus and tracking actuators (not shown) within the pickup 27 through the actuator drivers 36. The S-RAM 33 and the flash memory 34 temporarily stores operation data for the positional control and laser power control on the pickup 27 performed by the control microprocessor 37, as well as storing programs, etc., for example. Further, the nonvolatile memory 35 stores operation data such as the position of the pickup 27 calculated by the control microprocessor 37.

Now that the write operation has been described, the following description will be directed to the read operation. When a read operation is performed, the steps for the write operation described above are roughly followed in the reverse direction. That is, the read/write unit 41 reads data written on the disk medium 25 through the pickup 27 and the read circuit 28, converts the data which has a recording format suitable for the disk medium .25 into an MPEG-2 encoded digital signal by use of the signal/control processing circuit 29 and the control microprocessor 37, and sends it to the encode/decode processing circuit 7 through the interface circuit 19. Receiving the encoded digital signal, the encode/decode processing circuit 7 decodes it into video and audio signals. The video signal is input to the display means 10 and the video output terminal 11 through the video display/output processing circuit 12, while the audio signal is input to the audio output terminal 9 through the audio output circuit 8.

The power supply unit has the external power input terminal 22 for receiving power from outside. Further, the battery 23 is charged through the charging circuit 21 from an external power supply connected to the external power input terminal 22. When the external power supply is connected, the power supply circuit 24 converts the external power into required voltages, which are then supplied to each circuit and each means of this recording/reproducing apparatus. When the external power supply is not connected, the power from the battery 23 is fed to each circuit and each means through the power supply circuit 24.

Examples of disk media (25) for storing video signals include: DVD-ROM (Digital Versatile Disc Read Only Memory) for read only; DVD-R (Digital Versatile Disc Recordable) for rewriting only once; and DVD-RW (Digital Versatile Disc Rewritable) and DVD-RAM (Digital Versatile Disc Random Access Memory) for rewriting more than once.

The operation performed by the transcode function will be briefly described below.

First, in order for the camera-equipped recording/reproducing apparatus to initiate a transcode operation, the user selects the scene to be transcoded using a menu and initially sets the coding format (MPEG-4 ), the target image size, and the coding rate. Then, the recording/reproducing apparatus starts the transcode operation. Specifically, the read/write unit 41 reads data written on the disk medium 25, converts the data into an MPEG-2 encoded digital signal by use of the signal/control processing circuit 29, and sends it to the encode/decode processing circuit 7 through the interface circuit 19. Receiving the digital signal, the encode/decode processing unit 7 decodes it into video and audio data and then re-encodes the video and audio data into MPEG-4 format based on the initially set coding format (MPEG-4 ), target image size, and coding rate. After that, the encode/decode processing unit 7 sends the encoded digital signal the encoded video data and audio data to the read/write unit 41 through the interface circuit 19. Receiving the encoded digital signal, the read/write unit 41 converts the signal into a write format suitable for the disk medium 25 by use of the signal/control processing circuit 29 and writes it to the disk medium 25 through the write circuit 32 and the pickup 27. It should be noted that the coding rate varies depending on the rate of change of the input image or sound during the transcode operation. Even if the coding rate is initially set to 5 Mbps, it may increase to as high as 10 Mbps when the image becomes complicated or changes violently and hence the amount of data increases.

The power supply within a portable device such as a video camera does not always provide sufficient power. When the power has reached an insufficient level during a transcode operation, the battery may need to be replaced, requiring the transcode operation to be interrupted. Furthermore, the user may want to interrupt the transcode operation to take, reproduce, or edit a picture. When the transcode operation is interrupted due to a user operation or insufficient power, the recording/reproducing apparatus writes to the EEP-ROM 18 (memory means) such information as the read and write addresses on the disk medium 25 at the time of the interruption, the coding format, and the target image size and information indicating occurrence of an interruption so as to be able to later resume the transcode operation. The recording/reproducing apparatus interrupts the transcode operation in units of GOP. It should be noted that if there is no information on the coding rate at the time of the interruption, the transcode operation must be resumed with the coding rate set to its initial value, making it difficult to generate a stream which is continuous in terms of coding rate. For example, assume that the coding rate is 10 Mbps at the time of the interruption. That is, a large amount of data must be processed around this point of interruption. If the transcode operation is later resumed at this point with the coding rate set to the initial value 5 Mbps, it leads to a reduction in the amount of information which can be retrieved and hence a degradation in the quality of the image and sound. To address this problem, the present embodiment also stores information on the coding rate at the time of the interruption in the EEP-ROM 18 in order to resume the transcode operation so that the transcoded stream (around the point of interruption) is continuous also in terms of coding rate, thereby preventing a degradation in the quality of the image and sound at the point of interruption.

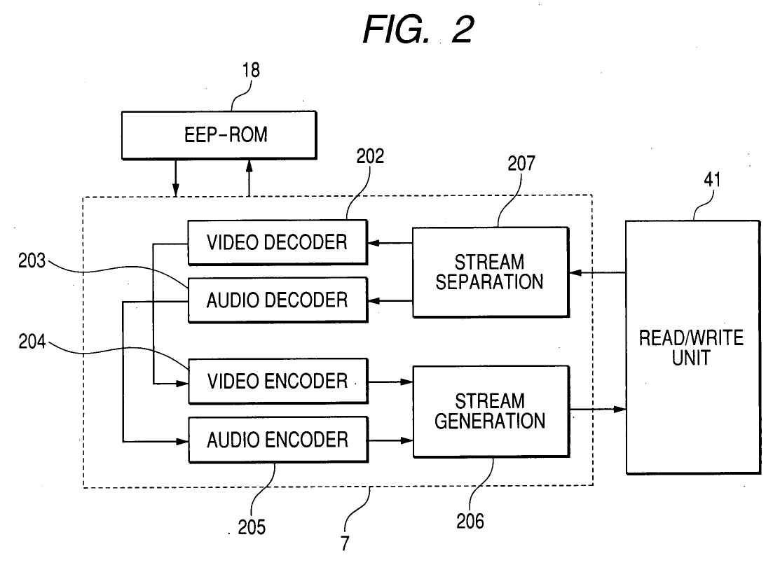

FIG. 2 is a block diagram showing the internal workings of the encode/decode processing circuit 7 and some components connected thereto in a transcode operation within the camera-equipped recording/reproducing apparatus employing an optical disk recording medium according to the present embodiment. First, to initiate a transcode operation, the read/write unit 41 reads data written on the disk medium 25 (a storage medium) and sends it to the encode/decode processing circuit 7 as an MPEG-2 encoded digital signal. Receiving the signal, the encode/decode processing circuit 7 decodes and then re-encodes it. Specifically, the encode/decode processing circuit 7 separates the received digital signal into coded video data and audio data by use of the stream separation section 207. Then, the video decoder 202 and the audio decoder 203 in the encode/decode processing circuit 7 decode the coded video data and audio data, respectively. The decoded video data and audio data are MPEG-4 encoded by the video encoder 204 and the audio encoder 205, respectively. After that, the encode/decode processing circuit 7 multiplexes the re-encoded video data and audio data by use of the stream generation section 206 to produce a digital signal, which constitutes stream data. Then, the encode/decode processing circuit 7 sends the digital signal to the read/write unit 41, which then writes the signal to the disk medium 25. When the transcode operation by the encode/decode processing circuit 7 is interrupted, the encode/decode processing circuit 7 writes to the EEP-ROM 18 such information as the read and write addresses on the disk medium 25 and the coding rate at the time of the interruption, the coding format, and the target image size and information indicating occurrence of an interruption. It should be noted that the above information, such as the coding rate, can be stored in any nonvolatile memory; for example, it may be stored in the flash memory 15. It should be further noted that the present embodiment is also advantageous in that it is possible to store the above information, such as the coding rate in the transcode operation, in a single place and thereby consolidate the management, since the present embodiment uses only a single processing circuit to perform both decoding and encoding.

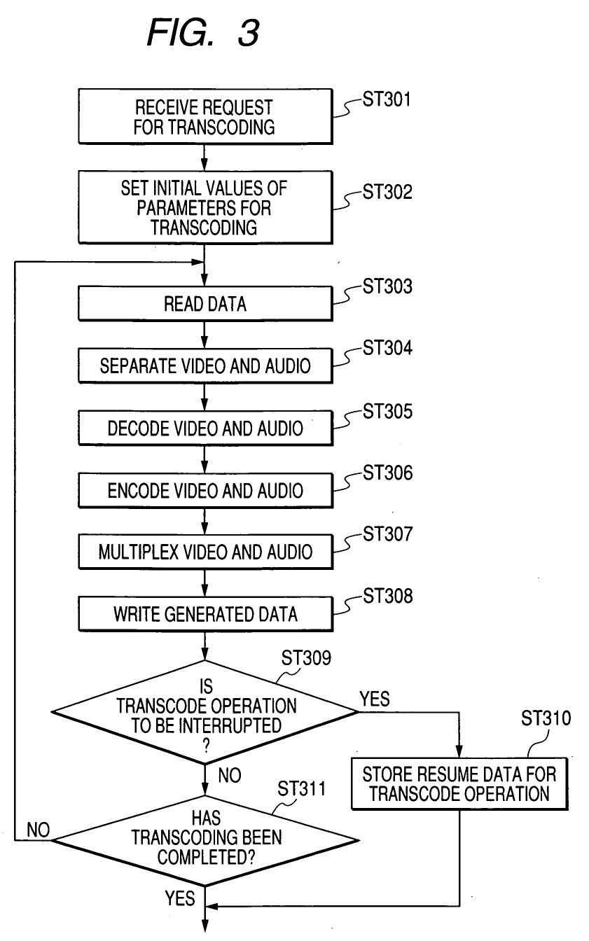

FIG. 3 is a flowchart showing the basic transcode operation performed by the camera-equipped recording/reproducing apparatus of the present embodiment upon reception of a request for transcoding.

First, the camera-equipped recording/reproducing apparatus performs the following 8 steps: receiving a request for transcoding made by a user through a predetermined operation (step ST301); receiving user selection of a scene to be transcoded using a menu, receiving initial values of transcode parameters such as coding rate, coding format, and target image size, storing these parameter values (referred to in this specification as “transcode information”) in the D-RAM 13, and initiating a transcode operation (step ST302); reading MPEG-2 encoded data from the disk medium 25 (step ST303); separating the read data into encoded video data and audio data (step ST304); decoding the encoded video data and audio data (step ST305); re-encoding the decoded video data and audio data into MPEG-4 format based on the transcode information obtained from the D-RAM 13 (step ST306); multiplexing the encoded video data and audio data to produce stream data (step ST307); and storing the generated stream data on the disk medium 25. Then, at step ST309, the camera control microprocessor 14 determines whether the transcode operation is to be interrupted. At that time, the camera control microprocessor 14 checks whether the power is sufficient, etc. If the transcode operation is to be interrupted due to insufficient power or user operation, then at step ST310 the recording/reproducing apparatus interrupts the transcode operation in units of GOP and stores in the EEP-ROM 18 transcode resume information such as the read and write addresses on the disk medium 25 and the coding rate at the time of the interruption and information indicating occurrence of an interruption as well as the initial values of parameters such as coding format and target image size before ending the processing. It should be noted that the user may want to take a picture during the transcode operation. To handle such a case, at step ST309 the camera control microprocessor 14 checks the photographing start button, the transcoding interrupt button, etc. to determine whether the transcode operation is to be interrupted. As a result, the user is less likely to miss photo opportunities. Further, the user may also want to reproduce or edit a picture. To handle this, the camera control microprocessor 14 checks the corresponding buttons, etc. to determine whether the transcode operation is to be interrupted, allowing the user to quickly start reproducing or editing the picture. If it is determined at step ST309 that the transcode operation is not to be interrupted, then at step ST311 the recording/reproducing apparatus determines whether the transcoding of the selected scene has been completed. If the transcoding has not yet been completed, processing returns to step ST303 and the transcode operation is repeated. If, on the other hand, the transcoding of the selected scene has been completed, the transcode operation is ended. It should be noted that the coding rate varies depending on the rate of change of the input image or sound, meaning that the coding rate may not be at its initial value when processing has returned to step ST303.

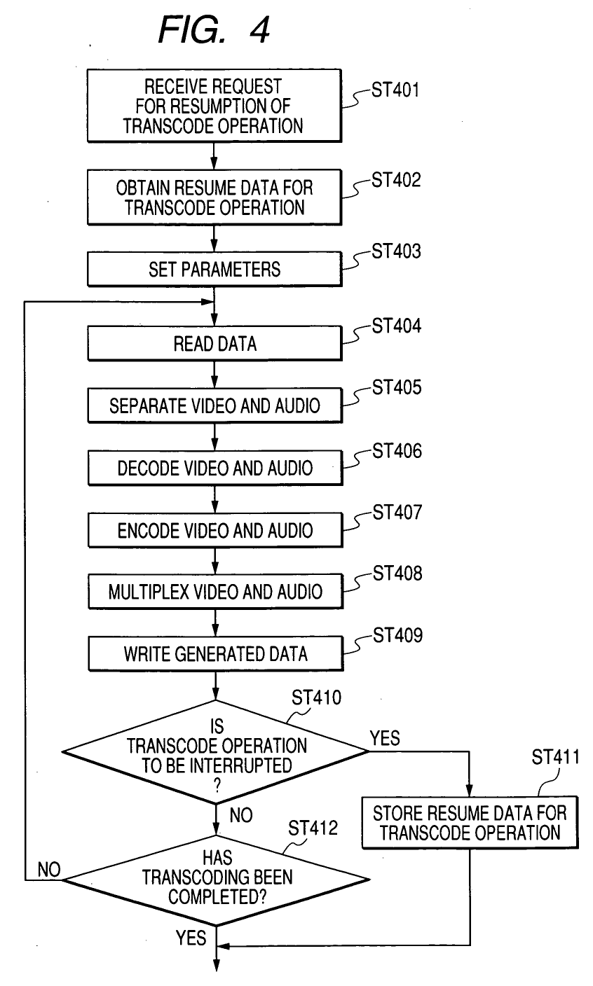

FIG. 4 is a flowchart showing the basic transcode operation performed by the camera-equipped recording/reproducing apparatus of the present embodiment upon reception of a request for resumption of a transcode operation. First, the camera-equipped recording/reproducing apparatus performs the following 9 steps: receiving a request for resumption of a transcode operation made by a user through a predetermined operation, and identifying the requested transcode operation based on the information indicative of occurrence of an interruption stored in the EEP-ROM 18 at step ST310 (step ST401); obtaining from the EEP-ROM 18 the transcode resume information, such as the read and write addresses and the coding rate at the time of the interruption, and the initial values of parameters such as coding format and target image size, and temporarily storing them in the D-RAM 13 (step ST402); setting parameters based on the obtained information and initial parameter values and resuming the transcode operation (step ST403); reading data from the address that was the read address at the time of the interruption (step ST404); separating the read data into encoded video data and audio data (step ST405); decoding the encoded video data and audio data (step ST406); based on the transcode information and the transcode resume information stored in the EEP-ROM 18, encoding the decoded video data and audio data (step ST407); multiplexing the encoded video data and audio data to produce stream data (step ST408); and storing the generated stream data to the disk medium 25. Then, at step ST410, the recording/reproducing apparatus determines whether the transcode operation is to be interrupted. If the transcode operation is to be interrupted, at step ST411 the recording/reproducing apparatus interrupts the transcode operation in units of GOP and writes transcode resume information to the EEP-ROM 18 before ending the processing. If, on the other hand, the transcode operation is not to be interrupted, then at step ST412 the recording/reproducing apparatus determines whether the transcoding of the selected program (scene) has been completed. If the transcoding has not yet been completed, processing returns to step ST404 and the transcode operation is repeated. If, on the other hand, the transcoding of the selected program (scene) has been completed, the transcode operation is ended. It should be noted that the coding rate varies depending on the rate of change of the input image or sound, meaning that the coding rate may not be at its initial value when processing has returned to step ST404.

As described above, the present invention resumes a transcode operation using the coding rate at the time of the interruption so that the transcoded stream is continuous in terms of coding rate, thereby preventing a degradation in the quality of the image and sound at the point of interruption.

Even though the present embodiment was described as using an optical disk as the recording medium 25 for storing stream data, the present invention is not limited to this particular type of recording medium. For example, a hard disk, a memory card, etc. may be used.

The recording/reproducing apparatus of the present embodiment described above reads data from the disk medium 25, transcodes the read data, and writes it back to the same disk medium 25. However, the transcoded data may be written back to a different recording medium than that from which it was read. For example, the data may be read from an optical disk and written back to a memory card.

The present embodiment was described as applied to a transcode operation in which MPEG-2 coded data is converted into MPEG-4 format. However, the prevent invention can be applied to other coding formats. For example, the present invention can be applied to any image coding format, such as MPEG-7 or H.264, and any voice coding format, such as linear PCM, G.726, AC3, or AAC.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications as fall within the ambit of the appended claims.

What is claimed is:

1. A recording/reproducing apparatus for transcoding encoded data, comprising:
an interruption determination unit which determines whether a transcode operation is to be interrupted; and
a memory unit which stores the coding rate at the time of said interruption, when said transcode operation is interrupted based on the determination by said interruption determination unit.

2. The recording/reproducing apparatus as claimed in claim 1, wherein when said transcode operation is interrupted based on the determination by said interruption determination unit, said memory unit stores positional information on said encoded data.

3. The recording/reproducing apparatus as claimed in claim 2, wherein said recording/reproducing apparatus is a video camera.

4. A method for transcoding encoded data in a recording/reproducing apparatus, comprising the steps of:
determining whether a transcode operation is to be interrupted; and
when said transcode operation is interrupted based on the determination, storing the coding rate at the time of said interruption.

5. The method as claimed in claim 4, further comprising a step of:
when said transcode operation is interrupted based on the determination, storing positional information on said encoded data.

6. A recording/reproducing apparatus having a transcode function to read out and decode encoded stream data written on a recording medium, re-encode said decoded stream data into a predetermined format, and store said re-encoded stream data to a recording medium, said recording/reproducing apparatus comprising:
a memory module which stores transcode resume information required to resume a transcode operation, when the transcode operation performed by said transcode function is interrupted.

7. The recording/reproducing apparatus as claimed in claim 6, wherein when said transcode operation is resumed, said recording/reproducing apparatus reads out said transcode resume information stored in said memory module, encodes stream data based on said read transcode resume information, and stores said encoded stream data on an arbitrary recording medium.

8. The recording/reproducing apparatus as claimed in claim 7, wherein said transcode resume information includes information on the coding rate at the time of said interruption.

9. A recording/reproducing apparatus for performing transcode processing to transcode encoded data, said recording/reproducing apparatus comprising:
an interruption determination unit which determines whether a transcode operation is to be interrupted; and
a memory unit which stores the coding rate at the time of said interruption, when said transcode operation is interrupted based on the determination by said interruption determination unit.
